(19) United States
(12) Patent Application Publication
(10) Pub. No.: US 2008/0169281 A1
(43) Pub. Date: Jul. 17, 2008

(54) Deep Fryer for Cooking Foodstuff

(75) Inventors: Cory Thomas Borovicka, San Francisco, CA (US); Michael Garman, Midlothian, VA (US); Anja Catharina Thomas, Richmond, VA (US); David Lee Jackson, Mechanicsville, VA (US); Jess Jay Schnell, Richmond, VA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HAMILTON BEACH/PROCTOR-SILEX, INC., Glen Allen, VA (US)

(21) Appl. No.: 11/623,456

(22) Filed: Jan. 16, 2007

(51) Int. Cl. A47J 37/12

(52) U.S. Cl. 219/441

(57) ABSTRACT

A deep fryer including a housing, a pot positioned in the housing and a basket which is removably positioned in the pot. The basket includes first and second handle attachment brackets that mount each of first and second handles to opposite sides of the basket.

### BACKGROUND OF THE INVENTION

The present application is directed to a deep fryer for cooking foodstuff using a liquid and, more particularly, to a deep fryer or cooking apparatus that permits a user to properly drain the cooked foodstuff before removing the cooked foodstuff from the deep fryer.

Deep fryers are a relatively common household or restaurant appliance that are used to cook or fry foodstuff, typically chicken breasts, turkey breasts, French fries or other foodstuff that is desired to be fried. A typical deep fryer includes a housing which holds the cooking oil or other liquid to be heated, a basket which is placed inside the housing which holds the foodstuff to be cooked and a lid to enclose the deep fryer. A heating coil, located inside the deep fryer, heats the liquid to a desired temperature.

When removing the cooked foodstuff from within the deep fryer, the hot liquid inside the deep fryer can create a potential safety hazard. It is desirable that a user properly drains the basket and foodstuff while the foodstuff is located within the deep fryer to assure that the hot liquid is not spilled outside of the deep fryer. In the same sense, it would be desirable to provide structure within the deep fryer that permits a user to properly drain the hot liquid from the foodstuff before the foodstuff is removed from the deep fryer.

When removing the basket from a conventional deep fryer, it is important that the user has full control over the basket to assure that hot liquid is not spilled outside of the deep fryer. It would be desirable to include handles on the basket that allow the user complete control over the motion of the basket as the basket is removed from the deep fryer. In the same sense, it would be desirable to provide a user with several options to remove the basket from the deep fryer. For instance, it would be desirable to provide one or more handles of varying shapes and locations to accommodate the needs and dexterity of a user.

Further, conventional deep fryers often come with several components or pieces that fit together, such as the lid, housing and basket. Typically, it is the user's responsibility to properly position the components together before cooking the foodstuff. However, this can create a safety hazard if the user does not properly assemble the deep fryer before beginning to cook the foodstuff. Therefore, it would be desirable to provide a deep fryer with a structure that assures that the components of the deep fryer are properly assembled before the deep fryer is used for cooking.

### BRIEF SUMMARY OF THE INVENTION

Briefly stated, the present invention is directed to a deep fryer for cooking foodstuff using a liquid. The deep fryer includes a housing and a pot positioned in the housing for receiving the liquid. A basket is removably positioned in the liquid inside the pot. A basket bracket is located on an interior surface of the pot above the liquid. The basket bracket suspends the basket above the liquid. The basket bracket also permits the basket to be tilted at a predetermined angle relative to the pot to remove or insert the basket from the pot.

In another aspect, the present invention is directed to a deep fryer. The deep fryer includes a housing and a pot positioned in the housing. A basket is removably positioned in the pot. The basket includes first and second handle attachment brackets that mount each of first and second handles to opposite sides of the basket.

### BRIEF DESCRIPTION OF THE SEVERAL VIEWS OF THE DRAWINGS

The foregoing summary, as well as the following detailed description of a preferred embodiment of the present invention, will be better understood when read in conjunction with the appended drawings. For the purpose of illustrating the invention described in the present application, there is shown in the drawings, an embodiment which is presently preferred. It should be understood, however, that the invention is not limited to the precise arrangements and instrumentalities shown. In the drawings:

FIG. 1 is a front right perspective view of a preferred embodiment of a deep fryer in accordance with the present invention;

FIG. 2 is a rear left perspective view of the deep fryer shown in FIG. 1 with certain parts removed for clarity;

FIG. 3 is a front perspective view of a pot, locating ring and handles of a basket of the deep fryer shown in FIG. 1;

FIG. 4 is a front perspective view of the deep fryer shown in FIG. 1 with certain parts removed for clarity;

FIG. 5 is a front right perspective view of the basket of the deep fryer shown in FIG. 1;

FIG. 6 is a rear left perspective view of the basket of the deep fryer shown in FIG. 1;

FIG. 7 is a left side cross-sectional elevational view of the deep fryer shown in FIG. 1;

FIG. 8 is a left side cross-sectional elevational view of the deep fryer shown in FIG. 1 showing the basket partially removed from the pot and tilted at a predetermined angle; and

FIG. 9 is a perspective view of a preferred embodiment of a steaming rack in accordance with the present invention.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of the dispensing blender and designated parts thereof. The terminology includes the above-listed words, derivatives thereof and words of similar import.

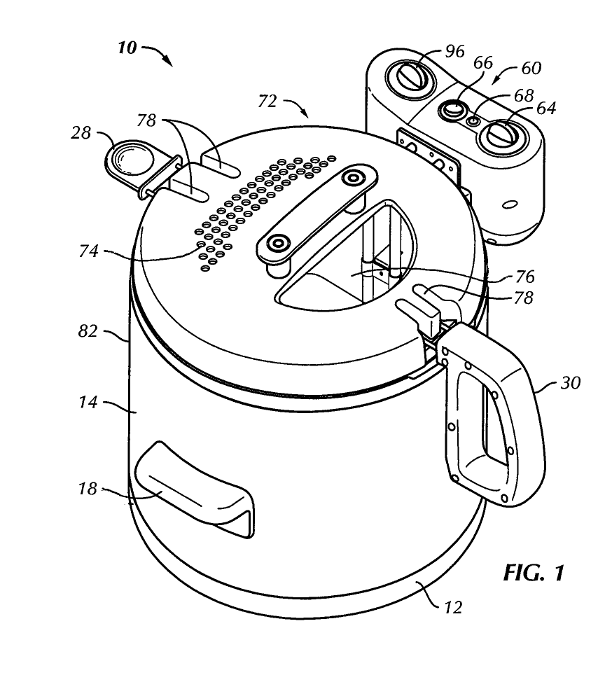

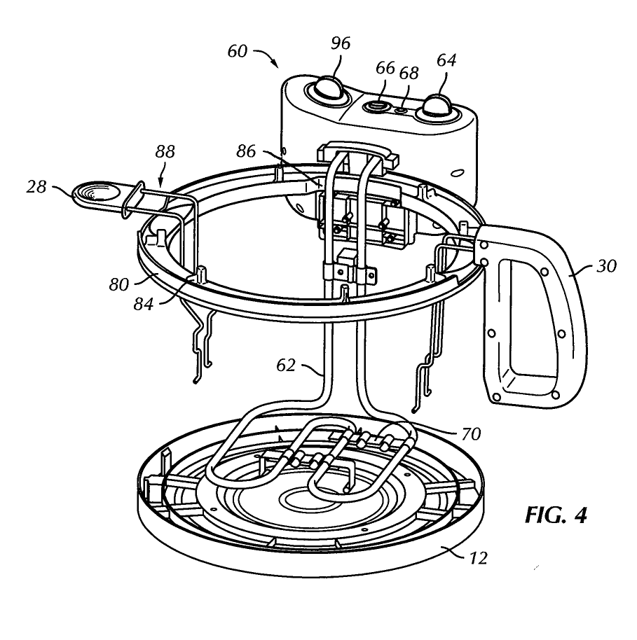

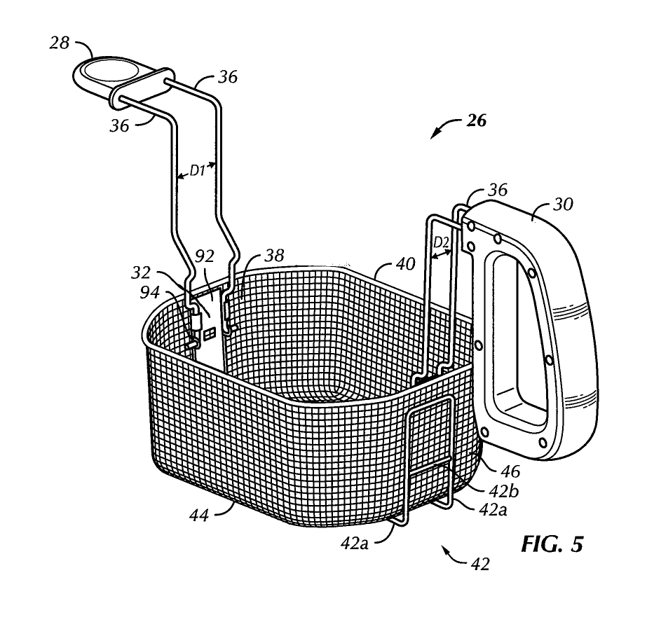

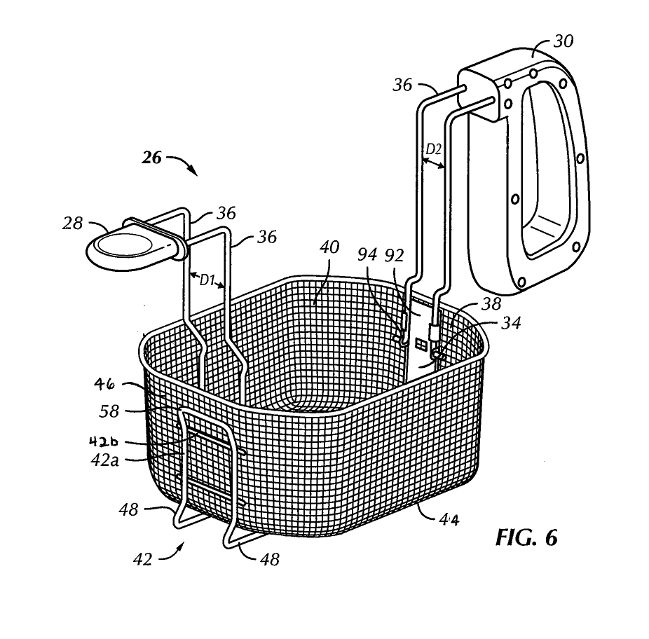

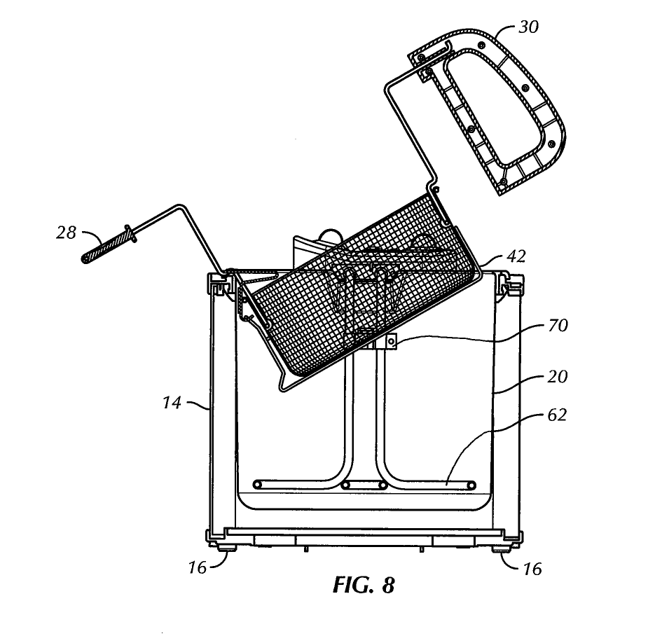

Referring now to the drawings in detail, wherein like numerals are used to indicate like elements throughout, there is shown in FIGS. 1-8 a preferred embodiment of a deep fryer, generally designated 10, for cooking foodstuff (not shown) using a cooking oil or other liquid (not shown). The deep fryer 10 is preferably in the form of a conventional kitchen deep fryer, but could be other products such as a crock pot or steamer machine. The deep fryer 10 includes a bottom cover 12 and a housing 14. The housing 14 is preferably formed of high strength, light weight material, such as a polymeric material. However, it is understood by those skilled in the art that the housing 14 can be constructed of a variety of materials that exhibit high strength and light weight characteristics without departing from the spirit and scope of the invention.

The housing 14 is supported by the bottom cover 12 which rests on a countertop or table top (not shown). The bottom cover 12 includes a plurality of feet 16 to assure that the deep fryer 10 is stably positioned on a countertop or table top. In the preferred embodiment, the housing 14 includes at least two lifting handles 18 on opposite sides to assist a user in lifting or positioning the deep fryer 10. It is understood by those skilled in the art that the lifting handles 18 are not required on the exterior of the housing 14. It is also understood that the handles 18 can take a variety of forms and shapes without departing from the spirit and scope of the invention.

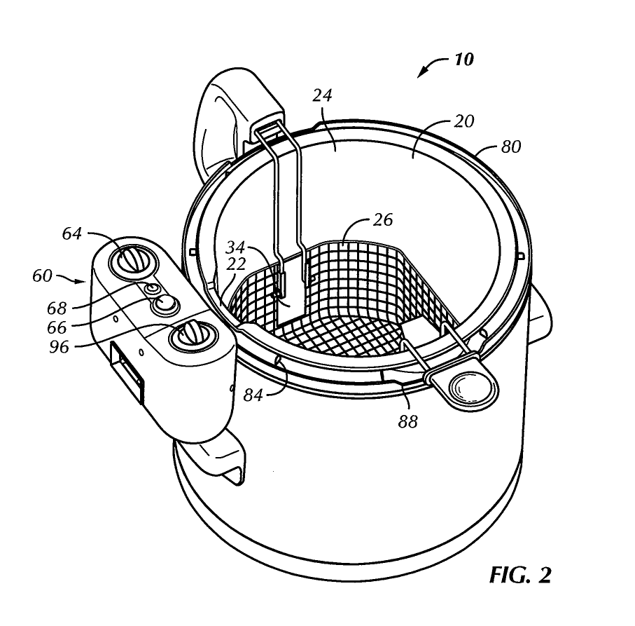

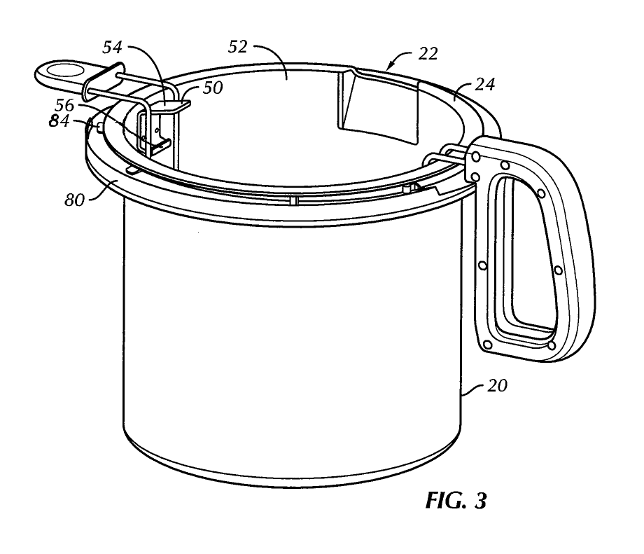

In reference to FIGS. 2 and 3, the deep fryer 10 includes a pot 20 positioned in the housing 14 for receiving a liquid. The pot 20 is preferably formed of a high strength, light weight material, such as a metal alloy. However, it is understood by those skilled in the art that other materials that are of high strength and light weight can be used to construct the pot 20. The pot 20 includes a pour spout 22 located at an upper rim 24. The pour spout 22 allows a user to easily drain the liquid from the interior of the pot 20. It is understood by those skilled in the art that the shape of the pour spout 22 can be in a variety of forms to allow a user to easily drain the liquid from the interior of the pot 20. It is also understood by those skilled in the art that the location of the pour spout 22 can be changed to allow a user to more easily drain the liquid from the interior of the pot 20. For instance, the pour spout 22 can be located on a side surface of the pot 20 or a plurality of pour spouts 22 can be located around the perimeter of the pot 20.

Referring now to FIGS. 2 and 5-8, a basket 26 is removably positioned in the liquid inside the pot 20. In the preferred embodiment, the basket 26 is formed of a mesh, or wire-like construction to allow the liquid to freely flow through the sides and bottom of the basket 26. The basket 26 is preferably formed of a high strength, light weight material such as a metallic alloy. However, it is understood by those of ordinary skill in the art that the basket 26 can be formed of other light weight and high strength materials that can withstand high temperatures. For example, the sides and bottom of the basket 26 can be substantially solid with holes formed therein to allow the liquid to freely flow through the sides and bottom of the basket 26.

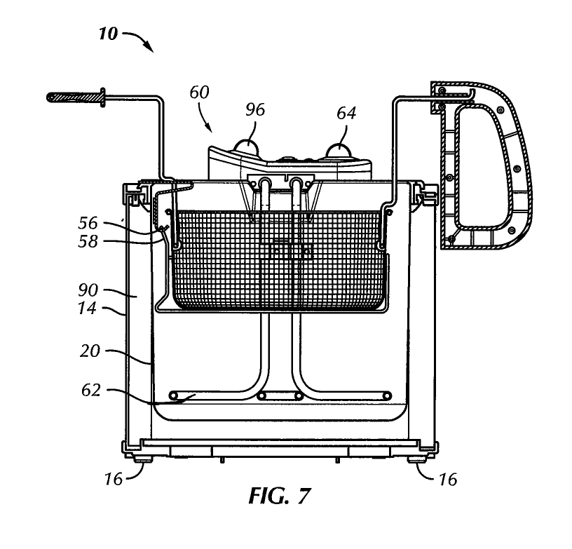

The basket 26 is preferably large enough to hold a chicken or turkey breast (not shown). However, the basket 26 is preferably small enough to allow the basket 26 to be raised and lowered within the pot 20 to submerge or separate the foodstuff from the liquid, as shown in FIGS. 2 and 7. It is understood by those skilled in the art that the size and shape of the basket 26 can be changed to accommodate the needs of the user without departing from the spirit and scope of the invention. For example, the basket 26 can be sized and shaped to specifically accommodate elongated French fries, such as in a long and narrow configuration. In the preferred embodiment, the basket 26 is sized and shaped to avoid contact with the heating coil assembly 62 (hereinafter described) when the basket 26 is placed inside the deep fryer 10. Specifically, a side wall of the basket 26 is flat to provide the proper spacing between the heating coil assembly 62 and the basket 26. A front wall of the basket 26 is also flat to provide proper symmetry to the basket 26.

In the preferred embodiment, the basket 26 includes at least two handles 28, 30 generally equidistantly spaced apart from each other and mounted to the basket 26. The handles 28, 30 provide improved stability to the basket 26 by allowing the user to control the basket 26 from one or both sides. The first and second handles 28, 30 each include a pair of spaced, generally parallel rods 36 that extend from an upper portion 38 of an interior surface of the basket 26. The rods 36 are bent to clear the pot 20, as shown in FIG. 2. Specifically, the rods 36 are bent to have a vertical portion which is parallel to a sidewall of the pot 20 and a horizontal portion which is perpendicular to a sidewall of the pot 20 when the basket 26 is horizontally positioned within the deep fryer 10. The horizontal portion of the rods 36 rest on the upper rim 24 of the pot 20 when the basket is in the horizontal and lowered position within the deep fryer 10.

In the preferred embodiment, a first distance D1 between the spaced rods 36 of the first handle 28 is greater than a second distance D2 between the spaced rods 36 of the second handle 30. The distances between the spaced rods 36 of the first and second handles 28, 30 are of unequal length to assure that the user properly positions the basket 26 in the deep fryer 10 in a manner which will hereinafter be described. In the preferred embodiment, the first handle 28 is generally L-shaped and the second handle 30 is generally D shaped. However, it is understood by those of skill in the art that the shape of the handles 28, 30 can be changed to allow a user greater control and maneuverability of the basket 26.

Further, the basket 26 includes first and second handle attachment brackets 32, 34 that each mount the rods 36 of the first and second handles 28, 30 to opposite sides of the basket 26. In the preferred embodiment, the first and second handle attachment brackets 32 and 34 each have a generally plate-shaped base 92 with two locking apertures 94 that extend perpendicular from the base 92 for capturing the distal portions of the rods 36. However, it is understood by those skilled in the art that the location and shape of the handle attachment brackets 32, 34 can be changed without departing from the spirit and scope of the invention. For example, the handle attachment brackets 32, 34 can be located on an exterior sidewall 46 of the basket 26 or can be of any form that allows a user to mount the rods 36 of the handles 28, 30 securely to the basket 26.

The mounting of the rods 36 of the handles 28, 30 to the handle attachment brackets 32, 34 is generally well known to those having ordinary skill in the art. In the preferred embodiment, the rods 36 of the handles 28, 30 are removably mounted to the handle attachment brackets 32, 34 of the basket 26. However, it is understood by those skilled in the art that the rods 36 of the handles 28, 30 are not limited to being removably mounted to the basket 26 by the handle attachment brackets 32, 34. The rods 36 of the handles 28, 30 may be removably mounted to the basket 26 in nearly any manner including clamps, bolts or other similar fastening devices. In addition, the handles 28, 30 are not limited to being removable from the basket 26 and may be fixed to or integral with the basket 26.

In the preferred embodiment, the basket 26 includes a stiffening frame 42 that extends across a bottom 44 of the basket 26 and along at least a portion of an exterior side wall 46 of the basket 26 proximate each of the first and second handles 28, 30. The stiffening frame 42 is comprised of a pair of generally parallel spaced apart elongated rods 42a which are maintained in spaced relation by perpendicular extending spaced apart rods 42b. The stiffening frame 42 of the basket 26 is bent to conform to the shape of the basket 26 and includes a nose 48 that extends from an exterior side wall 46 of the basket 26 proximate the first handle 28. The nose 48 of the stiffening frame 42 spaces the basket 26 from an interior side wall of the pot 20 by a predetermined distance when the basket 26 is located inside the pot 20. The nose 48 of the stiffening frame 42 assures that the basket 26 is maintained in the proper horizontal cooking position, and thus that the foodstuff is evenly cooked, when the basket 26 is located within the deep fryer 10. It is understood by those skilled in the art that the shape and location of the nose 48 can be changed without departing from the spirit and scope of the invention. The stiffening frame 42 is preferably formed of high strength, light weight material, such as steel. However, it is understood by those of ordinary skill in the art that the stiffening frame 42 can be formed of other light weight and high strength materials that can withstand high temperatures.

In reference to FIGS. 3, 7 and 8, a basket bracket 50 is located on an interior surface 52 of the pot 20 above the liquid. Specifically, the basket bracket 50 is located toward the upper rim 24 of the pot 20. The basket bracket 50 permits tilting of the basket 26 prior to removal or insertion of the basket 26 from within the pot 20. In the preferred embodiment, the basket bracket 50 includes a deflector bracket 54 and a hook bracket 56. The deflector bracket 54 of the basket bracket 50 extends toward an interior of the pot 20 and permits the basket 26 to be tilted to a predetermined angle relative to the pot 20 when the basket 26 is removed or inserted from the pot 20. In the preferred embodiment, the hook bracket 56 is located below the deflector bracket 54 on the basket bracket 50. The hook bracket 56 engages a hanger bracket 58 on an exterior surface of the basket 26 (top portion of the stiffening frame 42) which suspends the basket 26 in a horizontal position above the liquid as shown in FIG. 7. It is understood by those of skill in the art that the shape and form of the basket bracket 50 and hanger bracket 58 of the basket 26 can be of various forms and shapes to allow a user to position the basket 26 above the liquid in the pot 20 and to permit tilting of the basket 26 when the basket 26 is removed or inserted from the pot 20. For example, the basket bracket 50 can be integrally formed with an interior surface 52 of the pot 20. Further, the hanger bracket 58 can be shaped to hang over the rim of the pot 20 instead of on the hook bracket 56.

In the preferred embodiment, the first distance D1 between the spaced rods 36 of the first handle 28 is greater than the width of the basket bracket 50 so the spaced rods 36 of the first handle 28 permit the bracket 50 to be positioned therebetween. Further, the second distance D2 between the spaced rods 36 of the second handle 38 is less than the width of the basket bracket 50 so that the rods 36 of the second handle 30 do not permit the basket bracket 50 to be positioned therebetween. In this manner, the distances D1, D2 between the spaced rods 36 of the first and second handles 28, 30 assure that the user properly positions the basket 26 within the pot 20 with the D-shaped second handle 30 being positioned opposite the basket bracket 50. The D-shaped second handle 30 provides the user with greater control and stability of the basket 26 for inserting or removing the basket 26 from the pot 20.

In the preferred embodiment, the predetermined angle that is permitted to tilt the basket 26 relative to the pot 20 when removing or inserting the basket 26 from the pot 20 is at least 30 degrees. It has been found that permitting an angle of at least 30 degrees assures that hot liquid located within a breast cavity of a chicken, turkey or other foodstuff is properly drained before a user can completely remove the basket 26 from the pot 20. Thus, permitting a user to tilt the basket to at least a 30 degree angle assures that the hot liquid is drained from the foodstuff while the basket 26 is within the pot 20. The hot liquid is therefore drained from the basket 26 and returned to the interior of the pot 20 and the hot liquid does not create a potential safety hazard outside of the deep fryer 10.

Referring now to FIGS. 1, 2, 4, 7 and 8, a heating element controller 60 is removably mounted to the housing 14. Further, a heating coil assembly 62 is also removably mounted to the pot 20. The heating element controller 60 is operatively connected to the heating coil assembly 62 to allow a user to control the temperature attained by the liquid in the pot 20. The heating element controller 60 includes a thermostat knob 64, a timer knob 96, a power switch 66 and an indicator light 68 which provides the user a means to actively control the temperature reached by the liquid inside the pot 20. The heating element controller 60 also includes a safety shutoff button (not shown) that is generally well known to those of ordinary skill in the art. The safety shutoff button assures that the heating element controller 60 is properly positioned on to the deep fryer 10 before power is supplied to the heating coil assembly 62. Although the timer knob 96 of the preferred embodiment is in the form of a rotational knob that is generally well known in the art, it is understood by those of ordinary skill in the art that the timer knob 96 can be in the form of any time monitoring mechanism without departing from the spirit and scope of the invention. For example, the timer knob 96 can be in the form of a digital timer, including a digital display and a time setting button that permits the user to set the amount of cooking time.

The heating coil assembly 62 extends from the heating element controller 60 into the interior of the pot 20 to heat the liquid. The heating coil assembly 62 is removably mounted to the pot 20 to allow a user to more easily clean the deep fryer 10. It is understood by those of ordinary skill in the art that the form and shape of the heating element controller 60 and the heating coil assembly 62 can be changed or modified to allow a user to more accurately control the temperature attained by the liquid inside the pot 20. For example, the heating coil assembly 62 can extend around an exterior side wall of the pot 20 to more evenly distribute the heat. Further, the heating element controller 60 can be positioned toward a lower exterior portion of the housing 14 so that the heating element controller 60 does not block a section of the upper rim 24 of the pot 20. At least one bracket 70 attaches temperature and pressure probes (not shown) to the heating coil assembly 62 to allow the heating element controller 60 to properly monitor the temperature and pressure of the liquid within the deep fryer 10.

In reference to FIG. 1, a lid 72 is removably mounted to the housing 14. The lid 72 is preferably formed of high strength, light weight material, such as a polymeric material. However, it is understood by those skilled in the art that the lid 72 can be constructed of a variety of materials that exhibit high strength and light weight characteristics without departing from the spirit and scope of the invention. In the preferred embodiment, the lid 72 includes a louvered vent 74 and a window 76. The window 76 allows a user to view the foodstuff inside the deep fryer 10. The window 76 is preferably transparent. It is understood by those skilled in the art that the window 76 can be formed of any high strength, high temperature resistant material, such as a glass ceramic, without departing from the spirit and scope of the invention.

In the preferred embodiment, when a user desires to suspend the basket 26 from the hook bracket 56 of the basket bracket 50, it is not required to remove the lid 72 from the housing 14. At least two pairs of lifting slots 78, located toward an outer periphery of the lid 72 and which extend through the lid 72, are of sufficient width to allow the spaced rods 36 of the first and second handles 28, 30 to move through the lifting slots 78. This feature of the deep fryer 10 allows the basket 26 to assume the position shown in FIG. 2 or as shown in FIG. 7 while the lid 72 remains in place to help avoid the potential safety hazard that would occur if the liquid from inside the pot 20 was spilled outside the deep fryer 10.

In reference to FIGS. 2-4, a locating ring 80 is located at the upper rim 24 of the pot 20. The locating ring 80 is removably positioned between a top rim 82 of the housing 14 and the upper rim 24 of the pot 20. The locating ring 80 spaces the pot 20 relative to the housing 14 to provide an insulating air gap 90 between the housing 14 and the pot 20. The insulating air gap 90 provides a cool touch feature to the deep fryer 10 such that the housing 14 does not attain the high temperatures reached by the pot 20. The locating ring 80 includes a plurality of upward extending support posts 84, a pour spout cutout 86 and handle depressions 88. The support posts 84 of the locating ring 80 assure that the insulating air gap 90 is properly provided between the pot 20 and the housing 14. In the assembled configuration, the pour spout 22 of the pot 20 matches the pour spout cutout 86 in the locating ring 80 to ensure proper orientation of the pot 20 in the housing 14. The basket bracket 50 of the pot 20 mates with the first distance D1 of the spaced rods 36 of the first handle to ensure the proper orientation of the handles 28, 30 in the deep fryer 10. The handle depressions 88 of the located ring provide access to the flange of the pot 22 of grasping the pot 20.

In operation, when a user desires to cook foodstuff within the deep fryer 10, the user places the deep fryer 10 on a table top or countertop and assures that the deep fryer is stable. The user then removes the lid 72 from the top of the housing 14. Next, the user grasps either or both of the first and second handles 28, 30 to remove the basket 26 from within the pot 20. The user then fills a portion of the interior of the pot 20, which has been placed inside the housing 14 of the deep fryer 10, to a desired depth with the liquid that is used to cook the foodstuff. The liquid used to cook the foodstuff is typically oil. However, it is understood by those skilled in the art that other liquids can be used to cook or fry the foodstuff, such as water.

Once the liquid has been placed inside the pot 20, the heating element controller 60 is installed on the housing 14. Next, the user plugs in the power cord (not shown) of the deep fryer 10 into a conventional wall socket (not shown). The user then activates the power switch 66 of the heating element controller 60 and the thermostat knob 64 to set the desired temperature of the liquid. If desired, the timer knob 96 is set to a desired time.

While the basket 26 is outside of the deep fryer 10, a user places the foodstuff inside the basket 26. Next, as the user places the basket 26 inside the deep fryer 10, the basket must be tilted to at least a 30 degree angle to assure that the deflector bracket 54 of the basket bracket 50 does not prevent the basket 26 from being inserted into the pot 20. Once the basket has been tilted to the at least 30 degree angle and has cleared the deflector bracket 54 of the basket bracket 50, the user can then tilt the basket 26 back to a horizontal position and lower the basket 26 into the interior of the pot 20.

As the basket 26 is returned to a horizontal position inside the pot 20, the basket 26 is lowered within the pot 20 until the basket 26 rests on the heating coil assembly 62. In this position, the liquid within the pot 20 should be of sufficient depth such that the foodstuff within the basket 26 is completely submerged. The user then allows the basket 26 holding the foodstuff to cook or fry in the liquid inside the pot 20. When the foodstuff has been cooked, the user can grasp one or both of the first and second handles 28, 30 and move the basket 26 in a vertical direction inside the pot 20 until the hanger bracket 58 of the basket 26 engages the hook bracket 56 of the basket bracket 50. In this position, the basket 26 is above the liquid within the pot 20. The lid 72 of the deep fryer 10 does not need to be removed during this operation (see FIG. 7). Specifically, the lifting slots 78 in the lid 72 are of sufficient width to allow the spaced rods 36 of the handles 28, 30 to move through the lifting slots 78 so that the lid 72 does not need to be removed to drain the basket in the horizontal position. This positioning of the basket 26 inside the pot 20 allows the majority of the liquid to be drained from the basket and foodstuff into the bottom of the pot 20 where the hot liquid is located.

Once the user believes the majority of hot liquid has been drained from the foodstuff and basket 26, the user removes the lid 72 and begins to tilt the basket 26 to the at least 30 degree angle. This motion of the basket 26 allows remaining hot liquid located within the foodstuff, such as in a breast cavity of a chicken or turkey, to be drained before the foodstuff is removed from the deep fryer 10. Next, the user can remove the basket 26 from within the pot 20 of the deep fryer 10 making sure that the basket 26 clears the deflector bracket 54 of the basket bracket 50. After the basket 26 has been removed from the deep fryer 10 and the temperature of the deep fryer 10 and liquid has cooled, a user can remove the pot 20 from within the housing 14 and drain the liquid from the pot 20 through the pour spout 22.

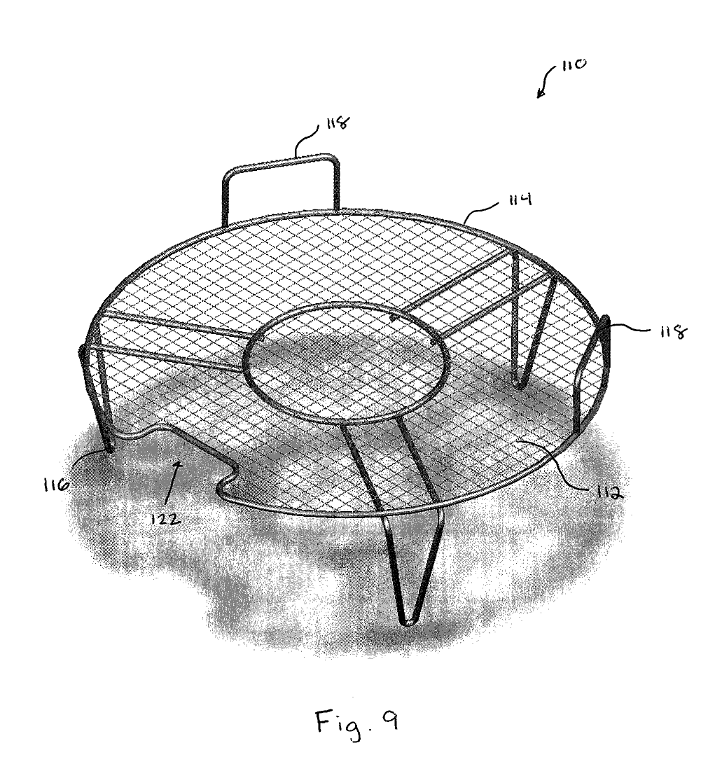

Referring to FIG. 9, there is shown a preferred embodiment of a steaming rack, generally designated 110, for cooking food items (not shown) in the deep fryer 10 without the basket 26. The steaming rack 110 is generally sized and shaped to be easily positioned inside and removed from the pot 20. When using the basket 26 as described above, a user fills a portion of the pot 20 of the deep fryer 10 with oil to surround and deep-fry food items. However, when using the steaming rack 110, a user places enough water in pot 20 of the deep fryer 10 to cover the lower, horizontal portion of a heating coil element 62 to steam food items from below the steaming rack 110.

The steaming rack 110 includes a screen 112, which holds the food items, connecting an outer periphery 114 of the rack 110. Three legs 116 extend from the bottom of the outer periphery 114 and two handles 118 extend from the top of the outer periphery 114 at spaced locations. Further, a cutout 122 in the outer periphery 114 allows the rack 110 to be properly placed inside the deep fryer 10 without interfering with the vertical portion of the heating coil assembly 62 of the deep fryer 10. The steaming rack 110 is preferably formed of a high strength, high temperature resistant material, such as a metallic alloy. However, it is understood by those skilled in the art that the steaming rack 110 can be formed of a variety of high strength and high temperature resistant materials without departing from the spirit and scope of the invention.

In operation, a user places enough water (not shown) in the pot 20 of the deep fryer 10 to cover the lower, horizontal portion of the heating coil assembly 62. A user then grasps the handles 118 and places the rack 110 inside the deep fryer 10, making sure to properly align the cutout 122 with the vertical portion of the heating coil assembly 62. The handles 118 allow the rack 110 to be raised or lowered inside the deep fryer 10. Next, a user places food items onto the top of the screen 112 for steaming. The length of the legs 116 allows the lower, horizontal portion of the heating coil assembly 62 to be completely immersed in water while the screen 112 and food items are above the water. The length of the legs 116 therefore provides a proper height for the screen 112 to allow for steaming.

Alternatively, before placing the rack 110 inside the deep fryer 10, a user can flip the rack 110 upside-down so that the two handles 118 extend from the bottom of the outer periphery 114 and the three legs 116 extend from the top of the outer periphery 116. When the rack 110 is placed inside the deep fryer 10, this orientation allows the food items to be boiled in the water since the screen 112 holding the food items is closer to the lower, horizontal portion of the heating coil assembly 62 and thus immersed in the water. In either orientation of the rack 110, the legs 116 or handles 118 ensure that the screen 112 is held above and off the lower, horizontal portion of the heating coil assembly 62.

It will be appreciated by those skilled in the art that changes could be made to the embodiment described above without departing from the broad inventive concept thereof. It is understood, therefore, that this invention is not limited to the particular embodiment disclosed, but is intended to cover modifications within the spirit and scope of the present invention as defined by the appended claims.

We claim:

1. A deep fryer for cooking foodstuff using a liquid, said deep fryer comprising:
a housing;
a pot positioned in said housing for receiving said liquid;
a basket removably positioned in said liquid in said pot; and
a basket bracket located on an interior surface of said pot above said liquid;
wherein said basket bracket suspends said basket above said liquid and permits said basket to be tilted at a predetermined angle relative to said pot to remove or insert said basket from said pot.

2. The deep fryer of claim 1, wherein said predetermined angle is at least 30 degrees.

3. The deep fryer of claim 1, further comprising:
a heating element controller and heating coil assembly removably mounted to said housing; and
a lid removably mounted to said housing.

4. The deep fryer of claim 3, wherein said lid includes a louvered vent and a window for viewing said foodstuff inside said deep fryer.

5. The deep fryer of claim 1, further comprising:
a lid removably mounted to said housing;
said basket bracket including:
a deflector bracket extending toward an interior of said pot which permits said basket to be tilted at said predetermined angle relative to said pot to remove or insert said basket from said pot; and
a hook bracket, said hook bracket engaging a hanger bracket on an exterior surface of said basket to suspend said basket above said liquid.

6. The deep fryer of claim 5, wherein suspending said basket from said hook bracket does not require removing said lid from said housing.

7. The deep fryer of claim 1, further comprising a pour spout located at an upper rim of said pot.

8. The deep fryer of claim 7, further comprising a locating ring, having a plurality of support posts and a pour spout cutout, attached to a top rim of said housing and said upper rim of said pot, said locating ring providing an insulating air gap between said housing and said pot.

9. The deep fryer of claim 1, wherein said basket further comprises at least two handles generally equidistantly spaced from each other and mounted to said basket.

10. The deep fryer of claim 9, wherein said basket includes first and second handle attachment brackets that each mount first and second handles to opposite sides of said basket.

11. The deep fryer of claim 10, wherein said basket further comprises a stiffening frame that extends across a bottom of said basket and an exterior sidewall of said basket proximate each of said first and second handles.

12. The deep fryer of claim 11, wherein said stiffening frame comprises a nose that extends from an exterior sidewall of said basket proximate said first handle.

13. The deep fryer of claim 1, further including a steaming rack.

14. A deep fryer comprising:
a housing;
a pot positioned in said housing, and
a basket removably positioned in said pot;
wherein said basket includes first and second handle attachment brackets that mount each of first and second handles to opposite sides of said basket.

15. The deep fryer of claim 14, wherein said first and second handles each comprises a pair of spaced rods that extend from an upper portion of an interior surface of said basket to said first and second handles, respectively.

16. The deep fryer of claim 15, wherein said first handle is generally L-shaped and said second handle is generally D-shaped.

17. The deep fryer of claim 15, wherein said basket further comprises a stiffening frame that extends across a bottom of said basket and an exterior sidewall of said basket proximate each of said first and second handles

18. The deep fryer of claim 17, wherein said stiffening frame comprises a nose that extends from an exterior sidewall of said basket proximate said first handle.

19. The deep fryer of claim 14, wherein a first distance between said spaced rods of said first handle is greater than a second distance between said spaced rods of said second handle.

20. The deep fryer of claim 19, wherein said pot includes a basket bracket located on an interior surface of said pot.

21. The deep fryer of claim 20, wherein said first distance between said spaced rods of said first handle is greater than a width of said basket bracket and said second distance between said spaced rods of said second handle is less than said width of said basket bracket.

22. The deep fryer of claim 14, further including a steaming rack.
